(19) United States
(12) Patent Application Publication
(10) Pub. No.: US 2006/0101631 A1
(43) Pub. Date: May 18, 2006

(54) METHOD AND EQUIPMENT FOR MANUFACTURING EXPANDABLE AND COLLAPSIBLE STRUCTURES

(75) Inventor: Theodore Zeigler, Alexandria, VA (US)

Correspondence Address: WHITE, REDWAY & BROWN LLP, 1217 KING STREET, ALEXANDRIA, VA, 22314, US

(73) Assignee: WORLD SHELTERS, INC., Alexandria, VA (US)

(21) Appl. No.: 10/904,590

(22) Filed: Nov. 17, 2004

(51) Int. Cl. B23Q 3/00; B25B 27/14

(52) U.S. Cl. 29/281.1; 29/464; 29/897.31

(57) ABSTRACT

In a method of assembling an expandable and collapsible structure, at least a first strut pair and a second strut pair are provided. The first strut pair and the second strut pair are attached to a second hub jig such that a first end of a first strut of the first strut pair is disposed proximate a first end of a second strut of the second strut pair. The first end of the first strut of the first strut pair and the first end of the second strut of the second strut pair are pivotably connected to form pivotably connected first and second strut pairs. The first and second strut pairs are attached to a first hub jig. A second end of a first strut of the second strut pair is pivotably connected to a second end of a second strut of the first strut pair.

The present invention relates to a method and equipment for manufacturing expandable and collapsible structures.

U.S. Pat. Nos. 6,141,934, 5,651,228, 5,444,946, 5,274,980, 5,230,196, RE33,710, 4,970,841, 4,838,003, 4,800,663, 4,761,929, 4,747,239, 4,689,932, 4,666,102, 4,637,180, 4,579,066, 4,561,618, 4,522,008, 4,512,097, 4,473,986, 4,437,275, 4,334,660, 4,290,244, 4,280,521, 4,026,313, and 3,968,808, which are incorporated by reference, disclose a variety of collapsible and expandable structures and components thereof. These structures vary in size, shape, and function. It is not uncommon for a structure in its expanded condition to be larger than the structure in its collapsed condition by substantially more than an order of magnitude. It has been common to manufacture these structures in an expanded condition. Consequently, a substantial amount of floor space is needed for the manufacture of such shelters, which adds to the cost of the structures. It is desirable to provide a method and equipment for manufacturing collapsible and expandable structures in a collapsed condition.

According to an aspect of the invention, a method of assembling an expandable and collapsible structure is provided. According to the method, at least a first strut pair and a second strut pair are provided. The first strut pair and the second strut pair are attached to a second hub jig such that a first end of a first strut of the first strut pair is disposed proximate a first end of a second strut of the second strut pair. The first end of the first strut of the first strut pair and the first end of the second strut of the second strut pair are pivotably connected to form pivotably connected first and second strut pairs. The first and second strut pairs are attached to a first hub jig. A second end of a first strut of the second strut pair is pivotably connected to a second end of a second strut of the first strut pair.

According to another aspect of the invention, a method of assembling an expandable and collapsible structure is provided. According to the method, at least a first, a second, a third, and a fourth strut pair are provided. The first, second, third, and fourth strut pair are attached to a second hub jig such that a first end of a first strut of each of the first, second, third, and fourth strut pair is disposed proximate a first end of a second strut of each of the second, third, fourth, and first strut pair, respectively. The first end of the first strut of the first, second, third, and fourth strut pair is pivotably connected to the first end of the second strut of the second, third, fourth, and first strut pair, respectively, to form pivotably connected first, second, third, and fourth strut pairs. The first, second, third, and fourth strut pairs are attached to a first hub jig. A second end of the first strut of the second, third, fourth, and first strut pair is pivotably attached to a second end of the second strut of the first, second, third, and fourth strut pair, respectively.

According to yet another aspect of the present invention, a method of assembling an expandable and collapsible structure is provided. According to the method, a strut pair having a first strut and a second strut is provided. The strut pair is attached to a jig such that a first end of the first strut is disposed proximate a first end of the second strut and a second end of the first strut is disposed proximate a second end of the second strut. An assembly including a telescoping strut having a first component having a first end adapted to slide inside of a second component, and an arm strut having a first end pivotably attached to the second component of the telescoping strut, is provided. While the strut pair is attached to the jig, a second end of the first component of the telescoping strut is pivotably connected to the second end of one of the first and second strut and a second end of the arm strut is pivotably connected to the first end of one of the first and second strut.

According to still another aspect of the present invention, an assembly jig for a collapsible and expandable structure, the structure including a plurality of strut pairs pivotably connected to one another by a plurality of first and second hubs, is provided. The assembly jig includes a pivotable frame, a first hub jig mounted to the frame, the first hub jig including a plurality of strut mounting points connectable to first ends of a plurality of struts of the structure to orient the plurality of struts relative to one another for attachment of second hubs to second ends of the plurality of struts, and a second hub jig mounted to the frame, the second hub jig including a plurality of hub mounting points connectable to second hubs attached to second ends of the plurality of struts to orient the plurality of struts relative to one another for attachment of first hubs to first ends of the plurality of struts.

### BRIEF DESCRIPTION OF THE DRAWINGS

The features and advantages of the present invention are well understood by reading the following detailed description in conjunction with the drawings in which like numerals indicate similar elements and in which:

FIGS. 1A-1I are schematic side views showing steps in a method of assembling an expandable and collapsible structure according to an embodiment of the present invention;

FIGS. 2A and 2B are perspective views showing, in an expanded and a collapsed state, respectively, an illustrative prior art expandable and collapsible structure which can be assembled using the method and equipment according to embodiments of the present invention;

FIGS. 3A and 3B are partially cross-sectional side views showing a portion of the structure of FIGS. 2A and 2B in an expanded and a collapsed state, respectively;

FIG. 4 is a perspective view showing a portion of structure of FIGS. 2A and 2B;

FIG. 5 is an exploded perspective view of an assembly jig according to an embodiment of the present invention;

FIG. 6 is a partially cross-sectional side view of a portion of an assembly jig according to an embodiment of the present invention;

FIG. 7 is a partially cross-sectional side view of another portion of an assembly jig according to an embodiment of the present invention;

FIG. 8 is an exploded perspective view of a hub according to an embodiment of the present invention;

FIG. 9A is partially cross-sectional side view of a hub and cable securing element and FIG. 9B is a top plan views of a cable securing element according to embodiments of the present invention; and

FIG. 10 shows superimposed patterns of strut mounting points and hub mounting points on portions of an assembly jig according to an embodiment of the present invention.

### DETAILED DESCRIPTION

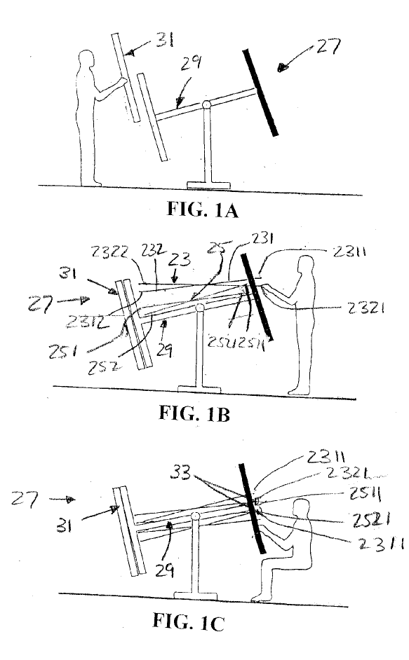

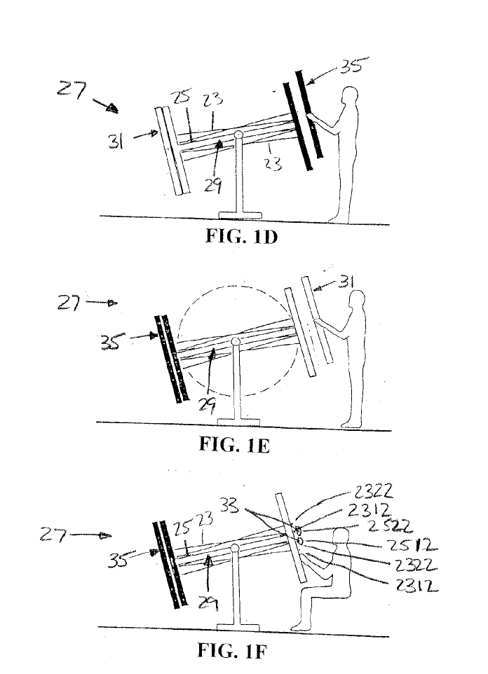

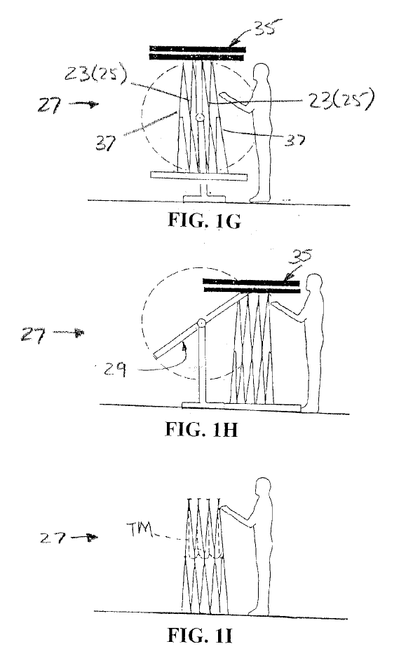

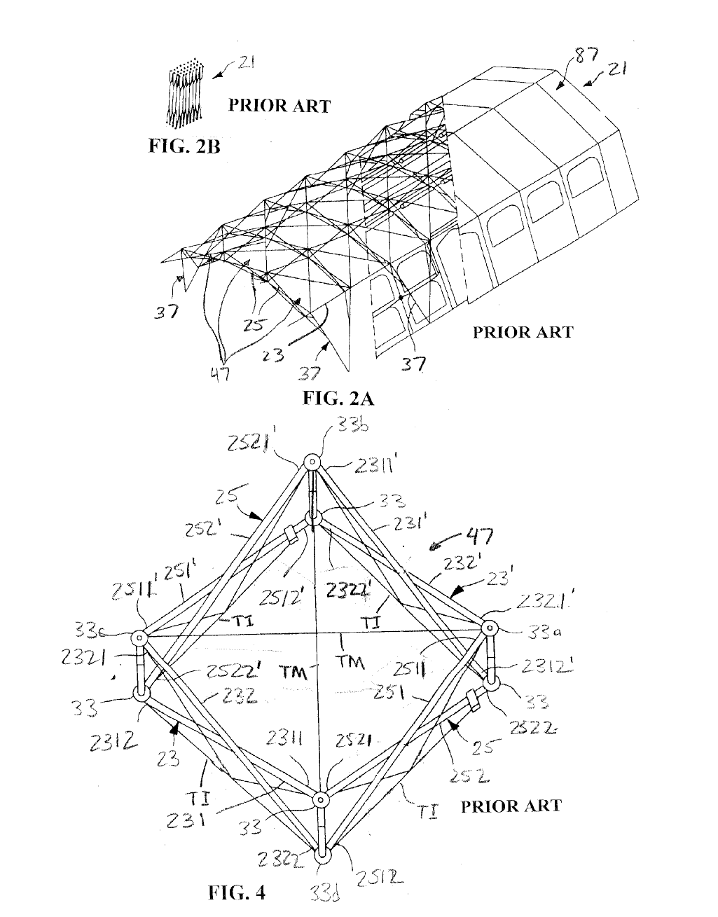

An embodiment of a method of assembling an expandable and collapsible structure is seen with reference to FIGS. 1A-1I. For purposes of discussion, the method will be illustrated in connection with the assembly of a structure of a type disclosed in U.S. Pat. No. 6,141,934, which is incorporated by reference. An embodiment of a structure 21 of a type disclosed in that patent is shown in an expanded condition (partially broken view) and a collapsed condition in FIGS. 2A and 2B, respectively. It will be appreciated, however, that methods according to the present invention can be used to assemble a wide variety of expandable and collapsible structures of the type including struts.

In an aspect of the method, at least a first strut pair 23 and a second strut pair 25 are provided. The first strut pair 23 and the second strut pair 25 each include first and second struts 231 and 232, and 251 and 252. In an embodiment of the present invention, a jig structure 27 including a frame 29 is used. Jig structures suitable for use in connection with the present invention can take a variety of suitable forms, an embodiment of one of which is seen in FIGS. 1A-1J. References to first, second, third, fourth, or further strut pairs, struts of strut pairs, ends of strut pairs, or other components of a structure are understood to be merely illustrative and used to distinguish parts that may be different or identical as required for a particular structure, and the particular forms of struts and strut arrangements described here are not intended to be limiting.

In the jig structure 27, what shall be denominated as a second hub jig 31 for purposes of discussion is attached to the frame 29 as seen in FIG. 1A. As seen in FIGS. 1B and 1C, the first strut pair 23 and the second strut pair 25 are attached to the second hub jig 31 such that a first end 2311 of a first strut of the first strut pair 23 is disposed proximate a first end 2521 of a second strut of the second strut pair 25. The second hub jig 31 is ordinarily disposed remote from the first ends of the struts, usually proximate the second ends of the struts, although the second hub jig can be located in any location that will facilitate proper relative positioning of the first ends of the struts for subsequent connection of those ends.

Ordinarily, when properly loaded on the second hub jig as seen in FIG. 1C, the struts of the strut pairs will be substantially parallel to one another to minimize the amount of space required to make the structure 21. Of course, for some structures, it may be useful to have some struts of the structure be non-parallel or perpendicular to other struts. As will be described further in connection with the description of embodiments of the jig structure, the strut pairs can be attached to the second hub jig by a variety of suitable techniques as a basic function of the second hub jig is to permit the strut pairs to be held in desired positions relative to one another.

The first end 2311 of the first strut of the first strut pair 23 and the first end 2521 of the second strut of the second strut pair 25 are pivotably connected to form pivotably connected first and second strut pairs as seen in FIG. 1C. Ordinarily, a discrete hub structure 33 is used to pivotably connect the first ends of the struts although, in some other structures, it may be desirable to, for example, directly connect the first ends of the struts to one another without a separate hub structure, i.e., the connected ends of the struts themselves may also define a “hub”.

As seen in FIG. 1D, the first and second strut pairs 23 and 25 are attached to what shall be denominated for purposes of discussion as a first hub jig 35. A second end 2512 of a first strut 251 of the second strut pair 25 is pivotably connected to a second end 2322 of a second strut 232 of the first strut pair 23 as seen in FIG. 1F. In some embodiments of the invention, the frame 29 is pivotable about an axis as seen in FIG. 1E so that the strut pairs can be turned around after connection of the first end 2311 of the first strut of the first strut pair 23 and the first end 2521 of the second strut of the second strut pair 25 (FIG. 1C) in order to pivotably connect the second end 2512 of the first strut 251 of the second strut pair 25 to the second end 2322 of the second strut 232 of the first strut pair 23 (FIG. 1F).

Ordinarily, as shown in FIGS. 1C and 1D, the first and second strut pairs 23 and 25 are attached to the first hub jig 35 after pivotably connecting the first end 2311 of the first strut 2311 of the first strut pair 23 and the first end 2521 of the second strut of the second strut pair 25 to form the pivotably connected first and second strut pairs. Also, as seen in FIGS. 1E and 1F, the second hub jig 31 is ordinarily removed before pivotably connecting the second end 2512 of the first strut 251 of the second strut pair 25 to the second end 2322 of the second strut 232 of the first strut pair 23. However, there may be circumstances when it will be desirable to attach the first hub jig 35 to the first and second strut pairs 23 and 25 before pivotably connecting the first end 2311 of the first strut 2311 of the first strut pair 23 and the first end 2521 of the second strut of the second strut pair 25, or when it will be desirable remove to the second hub jig 31 after pivotably connecting the second end 2512 of the first strut 251 of the second strut pair 25 to the second end 2322 of the second strut 232 of the first strut pair 23. Though not illustrated here, sequences of steps such as these are contemplated as within the scope of the present invention.

The struts 231 and 232 of the first strut pair 23 can be pivotably connected to each other, and the struts 251 and 252 of the second strut pair 25 can be pivotably connected to each other such as by a pin at some point remote from the ends of the struts to form scissor structures. Ordinarily, the struts 231 and 232 of the first strut pair 23 are pivotably connected to each other and the struts 251 and 252 of the second strut pair 25 are pivotably connected to each other before attaching the first strut pair 23 and the second strut pair 25 to the second hub jig 31. Ordinarily, it is expected that pre-connecting some or all of the struts of the strut pairs of a given structure before attaching them to the jigs will speed production. However, in some circumstances, it may be desirable to pivotably connect the struts after the struts are attached to the jigs discussed here, or to not pivotably connect some or all of the struts at all, and this is also contemplated as within the scope of the present invention.

In addition to typically pre-connecting strut pairs in a structure, it is also often desirable to provide certain tension members TI (FIG. 4) on individual strut pairs (or hubs at ends of individual strut pairs). Typically, tension members on individual strut pairs are in the form of cables and “cable keepers” for preventing the cables from becoming tangled during expanding or collapsing of the structure, although other forms of tension members can be used, such as detachable rigid elements, such as rods, or fabric, such as a tent cover. In embodiments of the structure shown in FIGS. 2A and 2B, tension members in the form of cables are provided between first ends of first and second struts of most or all of the strut pairs. The tension members can be and often are attached to the individual strut pairs prior to subsequently attaching the strut pairs to other strut pairs although, again, it will be appreciated that there may be instances when it will be desirable to attach tension members (if provided at all) to individual strut pairs after connecting the strut pairs to other strut pairs. Certain other tension members that are typically connected between different strut pairs, such as tension members TM (FIG. 4) that extend diagonally across modules, are usually best connected while or after pivotably connecting the different strut pairs to one another but may, if desirable, be connected before pivotably connecting the different strut pairs.

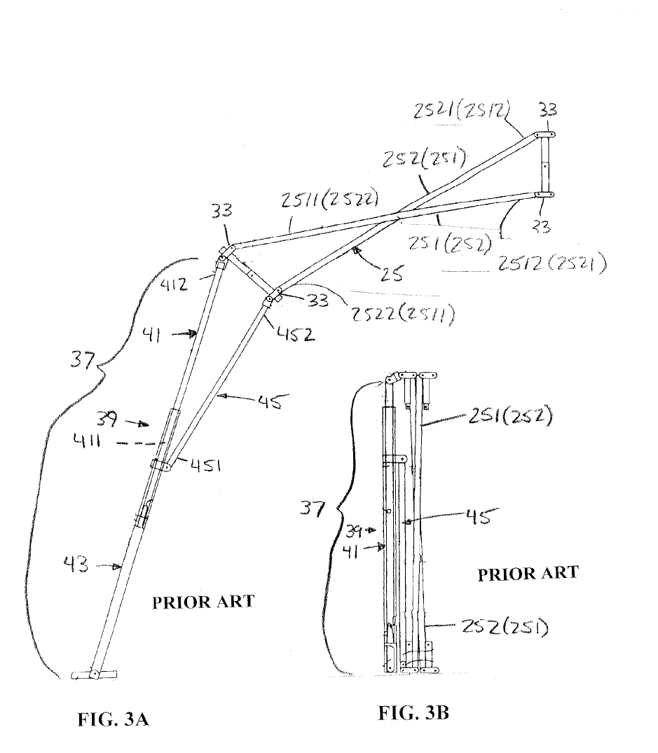

In the expandable and collapsible structure 21 seen in FIGS. 2A and 2B, leg structures 37 are connected to strut pairs 23 (or 25) as seen in expanded and collapsed conditions in FIGS. 3A and 3B. The first strut pair 23 and the second strut pair 25 are movable between the collapsed position in which the first and second struts 231 and 232 (FIG. 4) of the first strut pair and the first and second struts 251 and 252 of the second strut pair 25 are substantially parallel to one another (FIG. 3B) and an expanded position in which, ordinarily, the struts are non-parallel (FIG. 3A). In an aspect of the method according to the present invention, the steps of attaching the first strut pair 23 and the second strut pair 25 to the second hub jig 31, pivotably connecting the first end 2311 of the first strut of the first strut pair 23 and the first end 2521 of the second strut of the second strut pair 25, attaching the first and second strut pairs 23 and 25 to the first hub jig 35, and pivotably connecting the second end 2512 of the first strut 251 of the second strut pair 25 to the second end 2321 of the second strut 232 of the first strut pair 23 are performed while at least one of the first strut pair 23 and the second strut pair 25 is in a collapsed position. Ordinarily, to save space, to the extent that the assembly operations can be performed while strut pairs are in a collapsed condition, the will be. Of course, there may be other circumstances peculiar to certain structures that may make it desirable to perform assembly operations while some or all strut pairs are not in collapsed positions.

A method according to the present invention can also include, as seen in FIG. 1G, providing a leg assembly 37 including, as seen in FIG. 3A, a telescoping strut 39 having a first component 41 having a first end 411 adapted to slide inside of a second component 43, and an arm strut 45 having a first end 451 pivotably attached to the second component 43 of the telescoping strut. As seen in FIGS. 3A and 3B, a second end 412 of the first component 41 of the telescoping strut 39 is pivotably connected to a second end of at least one strut of at least one strut pair of the first and second strut pairs and a second end 452 of the arm strut 45 is pivotably connected to a first end of at least one strut of at least one strut pair of the first and second strut pairs, ordinarily while the first and second strut pairs 23 and 25 are attached to the first hub jig 35. As seen in FIG. 1G, it is generally considered to be easiest to attach the leg assembly 37 to the strut pairs when the strut pairs are in a collapsed condition and disposed in a substantially vertical orientation although it is anticipated that there may be circumstances where other strut pair conditions or orientations may be desirable.

Ordinarily, when the structure 21 is positioned with the struts in a vertical orientation, the structure is lowered from the frame as seen in FIGS. 1H and 1I and the structure is removed from the frame as seen in FIG. 1I. When so positioned, tension members TM such as cables can be applied to the hubs or struts. For example, a cover 87 can be attached to the second ends 2312, 2322, 2512, 2522 of the first and second struts of the first and second strut pair 23 and 25. The cover 87 may function as a tension member TM or it may be in addition to tension members in the form of, e.g., cables.

Referring to FIGS. 1A-1I, a method of assembling an expandable and collapsible structure according to the present invention is not, of course, limited to pivotably connecting two strut pairs. Often strut pairs are connected in groups to form modules 47 of interconnected strut pairs, such as the module shown in FIG. 4. For example, the method can involve providing at least a first and a second strut pair 23 and 25, as well as a third and a fourth strut pair which can be different from the first and second strut pair but, typically, are the same. Often, the first and third strut pairs will be identical and the second and fourth strut pairs will be identical, or all of the strut pairs will be identical. For purposes of discussion, the third strut pair 23′ will be described as being substantially identical to the first strut pair 23 and the fourth strut pair 25′ will be described as being substantially identical to the second strut pair 25.

In the method, the first, second, third, and fourth strut pairs 23, 25, 23′, and 25′ (reference numbers seen in FIG. 4) are attached to a second hub jig 31 (FIG. 1B) such that a first end 2311, 2511, 2311′, and 2511′ of a first strut 231, 251, 231′, and 251′ of each of the first, second, third, and fourth strut pair 23, 25, 23′, and 25′ is disposed proximate a first end 2521, 2321′, 2521′, and 2321 of a second strut 252, 232′, 252′, 232 of each of the second, third, fourth, and first strut pair, respectively. The first end 2311, 2511, 2311′, and 2511′ of the first strut 231, 251, 231′, and 251′ of the first, second, third, and fourth strut pair 23, 25, 23′, and 25′ is pivotably connected to the first end 2521, 2321′, 2521′, and 2321 of the second strut 252, 232′, 252′, and 232 of the second, third, fourth, and first strut pair, respectively, to form pivotably connected first, second, third, and fourth strut pairs (FIG. 1C). The first, second, third, and fourth strut pairs 23, 25, 23′, and 25′ are attached to a first hub jig (FIG. 1D). The second ends 2512, 2312′, 2512′, and 2312 of the first strut 251, 231′, 251′, and 231 of the second, third, fourth, and first strut pair 25, 23′, 25′, and 23 are pivotably connected to a second end 2322, 2522, 2322′, and 2522′ of the second strut 232, 252, 232′, and 252′ of the first, second, third, and fourth strut pair 23, 25, 23′, and 25′, respectively (FIG. 1F).

In the illustrated embodiment, the second ends 2512, 2312′, 2512′, and 2312 of the first strut 251, 231′, 251′, and 231 of the second, third, fourth, and first strut pair 25, 23′, 25′, and 23 are pivotably connected to a second end 2322′, 2522, 2322, and 2522′ of the second strut 232′, 252, 232, and 252′ of the third, second, first, and fourth strut pair 23′, 25, 23, and 25′, respectively, using first, second, third, and fourth second hubs 33a-33d (FIG. 4), respectively. As seen in FIG. 1I, a tension member TM such as a cable (although other structures such as a rod or a cover may be used instead or in addition) is provided between at least one of the first and third hub 33a and 33c and the second and fourth hub 33b and 33d, ordinarily between both the first and third hub and the second and fourth hub. As seen with reference to FIGS. 1H and 1I, one way of attaching the tension member TM is by arranging the struts so that they are in a substantially vertical position and then lowering the structure to the ground and releasing it from the assembly jig 27. In the position shown in FIG. 1I, the hubs 33 at the second ends of the strut pairs are accessible and tension members TM can be easily attached from hub to hub.

In the method, the steps of attaching the first, second, third, and fourth strut pair 23, 25, 23′, and 25′ to a second hub jig 31, pivotably connecting the first end 2311, 2511, 2311′, and 2511′ of the first strut 231, 251, 231′, and 251′ of the first, second, third, and fourth strut pair 23, 25, 23′, and 25′ to the first end 2521, 2321′, 2521′, and 2321 of the second strut 252, 232′, 252′ and 232 of the second, third, fourth, and first strut pair, respectively, attaching the first, second, third, and fourth strut pairs to a first hub jig 35, and pivotably connecting the second ends 2512, 2312′, 2512′, and 2312 of the first strut 251, 231′, 251′, and 231 of the second, third, fourth, and first strut pair 25, 23′, 25′, and 23 to the second end 2322, 2522, 2322′, and 2522′ of the second strut 232, 252, 232′, and 252′ of the first, second, third, and fourth strut pair, respectively, will ordinarily be performed while at least one of the first, second, third, and fourth strut pair is in a collapsed position. If desired, of course, some or all struts can be in an expanded condition. A leg assembly 37 can be attached to the module 47 formed in the manner described in a manner corresponding to the manner by which the leg assembly is elsewhere described as being attached to the strut pairs.

In attaching a leg assembly 37, the method can involve providing a strut pair, e.g., 25 having a first strut 251 and a second strut 252, attaching the strut pair to a jig 27 such that a first end 2511 of the first strut is disposed proximate a first end 2521 of the second strut and a second end 2512 of the first strut is disposed proximate a second end 2522 of the second strut as seen in FIG. 3B. The leg assembly 37 can include a telescoping strut 39 having a first component 41 having a first end 411 adapted to slide inside of a second component 43, and an arm strut 45 having a first end 451 pivotably attached to the second component 43 of the telescoping strut 39. Ordinarily, while the strut pair 25 is attached to the jig 27, a second end 412 of the first component 41 of the telescoping strut 39 is pivotably connected to the second end of one of the first and second strut and the second end 452 of the arm strut 45 is pivotably connected to the first end of one of the second and first strut, respectively. In the embodiment illustrated in FIGS. 3A and 3B, the second end 412 of the first component 41 of the telescoping strut 39 is pivotably connected to the first end 2511 (or the second end 2522) of the first strut 251 (or the second strut 252) of the strut pair 25 while the second end 452 of the arm strut is pivotably connected to the second end 2522 (or the first end 2511) of the second strut 252 (or the first strut 251) of the strut pair 25. As shown in parentheses, the ends of the various struts can be connected in an opposite fashion. The illustration showing the leg 37 connected to the strut pair 25 is merely illustrative and a leg can be connected to any suitable strut pair.

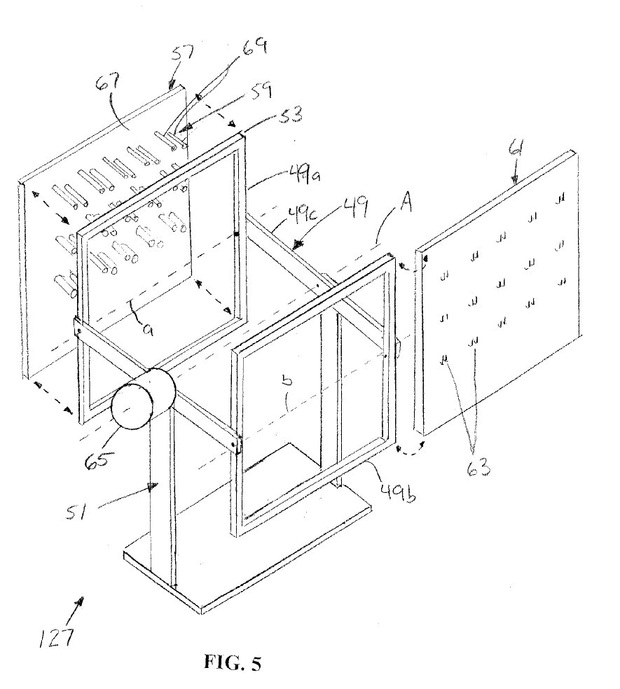

An embodiment of an assembly jig 127 for a collapsible and expandable structure is seen in FIG. 5. The assembly jig 127 may be the same as the jig 27 referred to in connection with the description of method aspects of the present invention although the method is not limited to the use of a particular jig, and the jig is not limited to performing a particular method. The assembly jig 127 can include a pivotable frame 49. The frame 49 can be pivotably mounted on a stand 51 to pivot about an axis A. In the illustrated embodiment, the frame 49 is substantially “I” shaped when viewed from the side, and defines a substantially square shape when viewed from either end. The frame 49 can have what shall be denominated as a first end 53 and a second end 55.

The assembly jig 127 can also include a second hub jig 57 mounted to the frame 49. The second hub jig 57 will ordinarily be removably mounted to the frame 49. The second hub jig 57 can include a plurality of strut mounting points 59 connectable to first ends of a plurality of struts of the structure to orient the plurality of struts relative to one another for attachment of second hubs to second ends of the plurality of struts. As elsewhere, references to “first” or “second” ends or hubs are used merely for purposes of reference during discussion and do not necessitate any relationship between parts of the structure to be assembled.

The assembly jig 127 can also include a first hub jig 61 mounted to the frame. The first hub jig 61 will also ordinarily be removably mounted to the frame 49. The first hub jig 61 can include a plurality of hub mounting points 63 connectable to second hubs attached to second ends of the plurality of struts to orient the plurality of struts relative to one another for attachment of first hubs to first ends of the plurality of struts. The second hub jig 57 and the first hub jig 61 can be removably mounted to the frame 49 by any suitable technique, such as with fasteners, hooks, and the like.

At least one of the second hub jig 57 and the first hub jig 61 can be pivotable relative to the frame or part of the frame. In FIG. 5, end parts 49a and 49b of the frame 49 to which the second hub jig 57 and the first hub jig 61 are removably mountable are pivotable relative to a center part 49c about axes a and b to permit the second hub jig 57 and/or the first hub jig 61 pivot relative to the center part of the frame. This facilitates lowering the structure to the ground while it remains in a collapsed condition with its struts primarily oriented in a vertical orientation as discussed with reference to the embodiment shown in FIGS. 1G, 1H and 1I. It is generally convenient to attach tension members TM from hub to hub when the structure 21 is in the collapsed condition with the struts oriented vertically.

The ability of the frame 49 to pivot relative to the stand 51 substantially simplifies the task of assembling components of the structure 21. A motor 65 or similar arrangement for pivoting the frame 49 between different positions can be provided. A control such as a servo-mechanism (not shown) or mechanical stops can be provided for stopping the frame 49 in various different desired pivot positions.

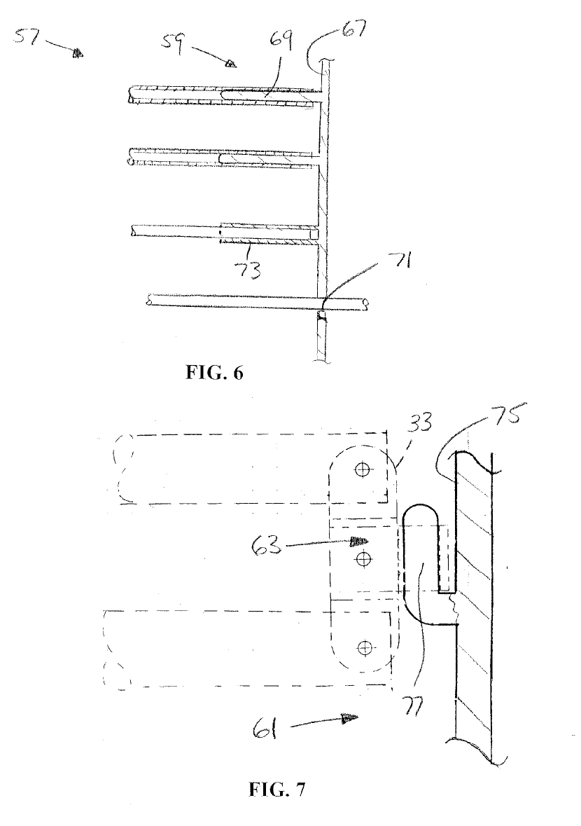

In the second hub jig 57 shown in FIG. 6, the second hub jig can include a frame 67 and the strut mounting points 59 can include a plurality of protruding members 69 on the frame. In the embodiment of FIG. 6, the protruding members 69 are adapted to be received inside ends of tubular struts. However, other forms of strut mounting points may be provided in addition to protruding members 69, or instead of such strut mounting points, such as by providing a plurality of openings 71 on the frame, the openings being adapted to receive ends of struts, or by providing a plurality of tubular protruding members 73 on the frame, the tubular protruding members being adapted to receive ends of struts.

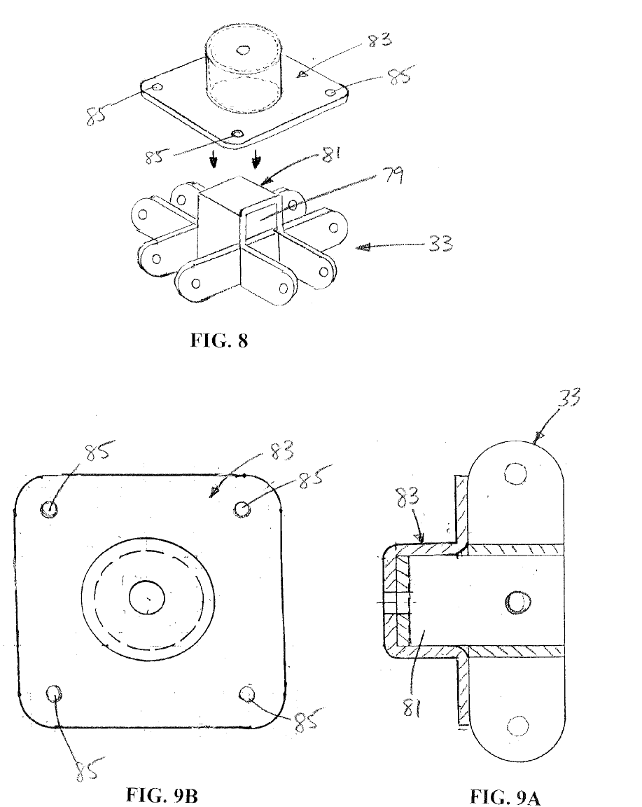

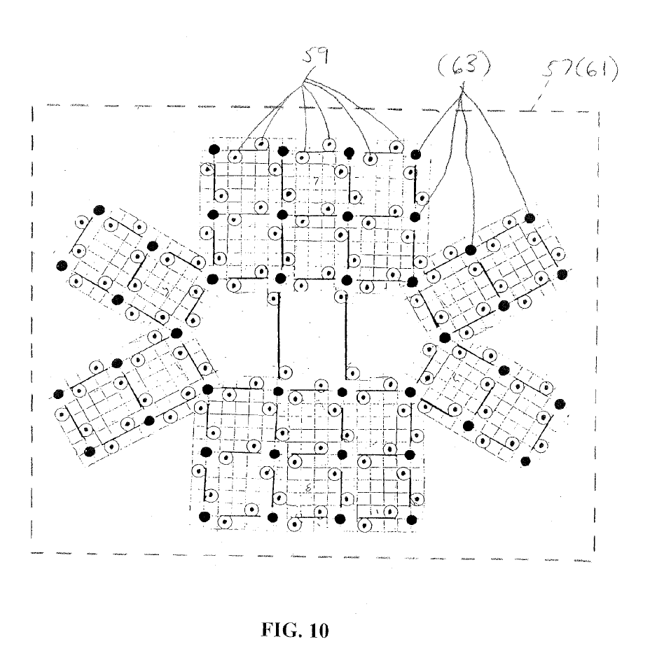

In the first hub jig 61 shown in FIG. 7, the first hub jig can include a frame 75 and the hub mounting points 63 can include a plurality of hooks 77 or similar structures on the frame for holding the second hubs 33 which can be provided with an opening for receiving the hooks. A presently preferred form of hub 33 can be used for all of the hubs and includes bent and welded or brazed components. As seen in FIG. 8, the hubs 33 include an opening 79 on a protruding part 81 of the hub facing away from the struts in which the hooks 77 can be received. In a presently preferred hub defining an outer part of the structure 21, as seen in FIGS. 8 and 9A, a cable securing element 83 is provided and fitted over the protruding part 81. Tension members TM in the form of cables are secured to holes 85 (FIGS. 8 and 9B) provided in the cable securing element 83. In addition, a fitting (not shown) can be provided on an inner part of the outer hub for assisting in securing, for example, an outer cover 87 (FIG. 2A) when the structure 21 is to be used as a shelter. The outer cover may function as a tension member in combination with or in lieu of tension members in the form of cables.

FIG. 10 shows an example of a grid laying out strut mounting points 59 (illustrated as circles with points at their centers) on a second hub jig 57 superimposed over a similar grid laying out hub mounting points 63 (shown as large black circles) on a first hub jig 61 (reference numerals 61 and 63 shown in parentheses). The illustrated layout facilitates construction of a structure having two groups of six connected modules (each group of six being arranged in two adjacent rows of three modules) and four groups of two connected modules, with the groups being connected to one another at hubs at inner corners of groups of interconnected modules. Other layouts can be provided to manufacture other forms of structures, as desired. In a method according to the present invention, struts are mounted with one end on the strut mounting points 59; and hubs are attached to ends of the struts remote from the strut mounting points. The hubs attached to the ends of the struts are then attached to the hub mounting points 63 on the first hub jig 61. The second hub jig 57 is removed from the struts and hubs are attached to ends of the struts that were previously mounted on the strut mounting points on the second hub jig. Tension members TM are connected to struts, hubs, or cable securing elements after the hubs are attached to the ends of the struts that were previously mounted on the strut mounting points on the second hub jig.

While this invention has been illustrated and described in accordance with a preferred embodiment, it is recognized that variations and changes may be made therein without departing from the invention as set forth in the claims.

What is claimed is:

1. A method of assembling an expandable and collapsible structure, comprising:
providing at least a first strut pair and a second strut pair;
attaching the first strut pair and the second strut pair to a second hub jig such that a first end of a first strut of the first strut pair is disposed proximate a first end of a second strut of the second strut pair;
pivotably connecting the first end of the first strut of the first strut pair and the first end of the second strut of the second strut pair to form pivotably connected first and second strut pairs;
attaching the first and second strut pairs to a first hub jig; and
pivotably connecting a second end of a first strut of the second strut pair to a second end of a second strut of the first strut pair.

2. The method as set forth in claim 1, wherein the first and second strut pairs are attached to the first hub jig after pivotably connecting the first end of the first strut of the first strut pair and the first end of the second strut of the second strut pair to form the pivotably connected first and second strut pairs.

3. The method as set forth in claim 2, comprising removing the second hub jig before pivotably connecting the second end of the first strut of the second strut pair to the second end of the second strut of the first strut pair.

4. The method as set forth in claim 1, comprising pivotably connecting the struts of the first strut pair to each other and the struts of the second strut pair to each other.

5. The method as set forth in claim 4, wherein the struts of the first strut pair are pivotably connected to each other and the struts of the second strut pair are pivotably connected to each other before attaching the first strut pair and the second strut pair to the second hub jig.

6. The method as set forth in claim 1, wherein, in the expandable and collapsible structure, the first strut pair and the second strut pair are movable between a collapsed position in which the first and second struts of the first and second strut pairs are substantially parallel to one another and an expanded position, the steps of attaching the first strut pair and the second strut pair to the second hub jig, pivotably connecting the first end of the first strut of the first strut pair and the first end of the second strut of the second strut pair, attaching the first and second strut pairs to the first hub jig, and pivotably connecting the second end of the first strut of the second strut pair to the second end of the second strut of the first strut pair being performed while at least one of the first strut pair and the second strut pair is in a collapsed position.

7. The method as set forth in claim 1, further comprising providing an assembly including a telescoping strut having a first component having a first end adapted to slide inside of a second component, and an arm strut having a first end pivotably attached to the second component of the telescoping strut and, while the first and second strut pairs are attached to the first hub jig, pivotably connecting a second end of the first component of the telescoping strut to a second end of at least one strut of at least one strut pair of the first and second strut pairs and pivotably connecting a second end of the arm strut to a first end of at least one strut of at least one strut pair of the first and second strut pairs.

8. The method as set forth in claim 1, further comprising attaching a cover to the second ends of the first and second struts of the first and second strut pair.

9. A method of assembling an expandable and collapsible structure, comprising:
providing at least a first, a second, a third, and a fourth strut pair;
attaching the first, second, third, and fourth strut pair to a second hub jig such that a first end of a first strut of each of the first, second, third, and fourth strut pair is disposed proximate a first end of a second strut of each of the second, third, fourth, and first strut pair, respectively;
pivotably connecting the first end of the first strut of the first, second, third, and fourth strut pair and the first end of the second strut of the second, third, fourth, and first strut pair, respectively, to form pivotably connected first, second, third, and fourth strut pairs;
attaching the first, second, third, and fourth strut pairs to a first hub jig; and
pivotably connecting a second end of the first strut of the second, third, fourth, and first strut pair to a second end of the second strut of the first, second, third, and fourth strut pair, respectively.

10. The method as set forth in claim 9, comprising connecting the second end of the first strut of the second, third, fourth, and first strut pair to the second end of the second strut of the first, second, third, and fourth strut pair, respectively, using first, second, third, and fourth second hubs, respectively.

11. The method as set forth in claim 10, comprising providing a tension member between at least one of the first and third hub and the second and fourth hub.

12. The method as set forth in claim 10, comprising providing a tension member between both the first and third hub and the second and fourth hub.

13. The method as set forth in claim 9, wherein, in the expandable and collapsible structure, the first, second, third, and fourth strut pair are movable between a collapsed position in which the first and second struts of the first, second, third, and fourth strut pairs are substantially parallel to one another and an expanded position, the steps of attaching the first, second, third, and fourth strut pair to a second hub jig, pivotably connecting the first end of the first strut of the first, second, third, and fourth strut pair and the first end of the second strut of the second, third, fourth, and first strut pair, respectively, attaching the first, second, third, and fourth strut pairs to the first hub jig, and pivotably connecting the second end of the first strut of the second, third, fourth, and first strut pair to the second end of the second strut of the first, second, third, and fourth strut pair, respectively, being performed while at least one of the first, second, third, and fourth strut pair is in a collapsed position.

14. The method as set forth in claim 9, further comprising providing an assembly including a telescoping strut having a first component having a first end adapted to slide inside of a second component, and an arm strut having a first end pivotably attached to the second component of the telescoping strut and, while the first, second, third, and fourth strut pairs are attached to the first hub jig, pivotably connecting a second end of the first component of the telescoping strut to a second end of at least one strut of at least one strut pair of the first, second, third, and fourth strut pairs and pivotably connecting a second end of the arm strut to a first end of at least one strut of at least one strut pair of the first, second, third, and fourth strut pairs.

15. A method of assembling an expandable and collapsible structure, comprising:
providing a strut pair having a first strut and a second strut;
attaching the strut pair to a jig such that a first end of the first strut is disposed proximate a first end of the second strut and a second end of the first strut is disposed proximate a second end of the second strut;
providing an assembly including a telescoping strut having a first component having a first end adapted to slide inside of a second component, and an arm strut having a first end pivotably attached to the second component of the telescoping strut; and
while the strut pair is attached to the jig, pivotably connecting a second end of the first component of the telescoping strut to the second end of one of the first and second strut and pivotably connecting a second end of the arm strut to the first end of one of the first and second strut.

16. An assembly jig for a collapsible and expandable structure, the structure including a plurality of strut pairs pivotably connected to one another by a plurality of first and second hubs, comprising:
a pivotable frame;
a first hub jig mounted to the frame, the first hub jig including a plurality of strut mounting points connectable to first ends of a plurality of struts of the structure to orient the plurality of struts relative to one another for attachment of second hubs to second ends of the plurality of struts; and
a second hub jig mounted to the frame, the second hub jig including a plurality of hub mounting points connectable to second hubs attached to second ends of the plurality of struts to orient the plurality of struts relative to one another for attachment of first hubs to first ends of the plurality of struts.

17. The assembly jig as set forth in claim 16, wherein the first hub jig is removably mounted to the frame.

18. The assembly jig as set forth in claim 17, wherein at least one of the first hub jig and the second hub jig is pivotable relative to the frame.

19. The assembly jig as set forth in claim 17, wherein the second hub jig is removably mounted to the frame.

20. The assembly jig as set forth in claim 16, wherein the second hub jig is removably mounted to the frame.

21. The assembly jig as set forth in claim 20, wherein at least one of the first hub jig and the second hub jig is pivotable relative to the frame.

22. The assembly jig as set forth in claim 16, further comprising a motor for pivoting the frame between different positions.

23. The assembly jig as set forth in claim 16, wherein the first hub jig includes a frame and the strut mounting points include a plurality of protruding members on the frame, the protruding members being adapted to be received inside ends of tubular struts.

24. The assembly jig as set forth in claim 16, wherein the first hub jig includes a frame and the strut mounting points include a plurality of openings on the frame, the openings being adapted to receive ends of struts.

25. The assembly jig as set forth in claim 16, wherein the first hub jig includes a frame and the strut mounting points include a plurality of tubular protruding members on the frame, the tubular protruding members being adapted to receive ends of struts.

26. The assembly jig as set forth in claim 16, wherein the second hub jig includes a frame and the hub mounting points include a plurality of hooks on the frame for holding the second hubs.
